(19) United States
(12) Patent Application Publication
(10) Pub. No.: US 2008/0301744 A1
(43) Pub. Date: Dec. 4, 2008

(54) Method and Apparatus for Locating Content in an Internet Protocol Television (IPTV) System

(75) Inventor: George T. Hutchings, Doylestown, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/755,417

(22) Filed: May 30, 2007

(51) Int. Cl. H04N 7/173

(52) U.S. Cl. 725/110

(57) ABSTRACT

A set top box includes a front-end (e.g., a network interface) for receiving programming content over a broadband communication network and a processor operatively associated with the front-end. The set top box also includes a resolver operatively associated with the processor for determining a network-level multicast address corresponding to a domain name of a virtual channel on which the broadcast programming is available.

### FIELD OF THE INVENTION

The present invention relates generally to a method and apparatus for using Internet Protocol (IP) addresses to access broadcast programming, and more particularly to a method and apparatus for accessing broadcast programming by obtaining their IP multicast addresses from the virtual channels of the broadcast programming.

### BACKGROUND OF THE INVENTION

A television may access programming content through a variety of transmission technologies such as cable, satellite, or over the air, in the form of analog or digital signals. In addition to broadcast and cable technologies, the Internet is emerging as a television content transmission medium. Television that receives content through an Internet network connection via the Internet Protocol (IP) may be generically referred to as IPTV. IPTV has become a common denominator for systems in which television and/or video signals are distributed to subscribers over a broadband connection using Internet protocols. In general, IPTV systems utilize a digital signal that is sent by way of a broadband connection and a set top box (“STB”) that is programmed with software that can fulfill subscriber requests to access media sources via a television connected to the STB. A decoder in the STB handles the task of decoding received IPTV video signals and converting them to standard television signals for display on a television. Where adequate bandwidth exists, IPTV is capable of a rich suite of services similar to those provided by digital cable television distribution methods

To view a television program being transmitted to a user's television, the user provides a channel number to the television. In conventional analog broadcast television, this channel number is a reference to a particular frequency band at which the analog signal carrying the television program is broadcast. This frequency band is also referred to as a “physical channel.” The channel number identifies the unique frequency band to which the television is to tune. Thus, there is a direct one-to-one relationship between the channel number selected on the television by the user and the actual frequency assigned to that channel.

In digital television, however, a frequency band can carry multiple channels. That is, there is a one-to-many relationship between the physical channel and the channel selected on the television. Accordingly, a single physical channel can include multiple items or “virtual channels.” In digital broadcasting, a plurality of multiplexed virtual channels are formed in a physical channel, and a program is broadcast on each virtual channel. In this case, the channel number selected by a user refers to a virtual channel, a particular item encoded within a transport stream, instead of referring to a physical channel.

One example of a standard used in digital television is defined by Digital Television Standard, by the Advanced Television Systems Committee (ATSC) Standard In this standard a virtual channel is defined as having a major channel number and a minor channel number in the form X.Y where “X” is the major channel number and “Y” is the minor channel number. By splitting a virtual channel into major and minor components, a broadcaster can maintain its channel identity, and at the same time provide multiple programs. Thus, a broadcaster can provide its analog programming on channel C (where “C” is a positive whole number), a first digital programming on channel C.1, a second digital programming on channel C.2, and so on. In digital television, broadcasters can map one or more major channels to one or more physical channels.

In an IPTV system it is not sufficient to simply know the virtual channel on which the desired program is being broadcast. Rather, the IP address of the desired channel source also must be known. Requiring the user to determine the appropriate IP address after already selecting the desired virtual channel is both difficult and inconvenient for the user. Accordingly, when IP digital television is employed, there is a need to establish a mechanism that is transparent to the user for locating the appropriate IP address that corresponds to the virtual channel selected by the user.

### BRIEF DESCRIPTION OF THE DRAWINGS

FIG. 1 shows the architecture of one example of a communication system that can be used to deliver video and other content and services to subscribers in a packet switched manner using an IP or other network-level protocol.

FIG. 2 shows one example of the client devices depicted in FIG. 1 interacting with a DNS server.

FIG. 3 is a flowchart showing one example of a method employed by a subscriber to access a multicast broadcast.

FIG. 4 shows the logical architecture of one particular example of client device shown in FIG. 2.

FIG. 5 shows one example of the hardware that may employed by the architecture of FIG. 4.

### DETAILED DESCRIPTION

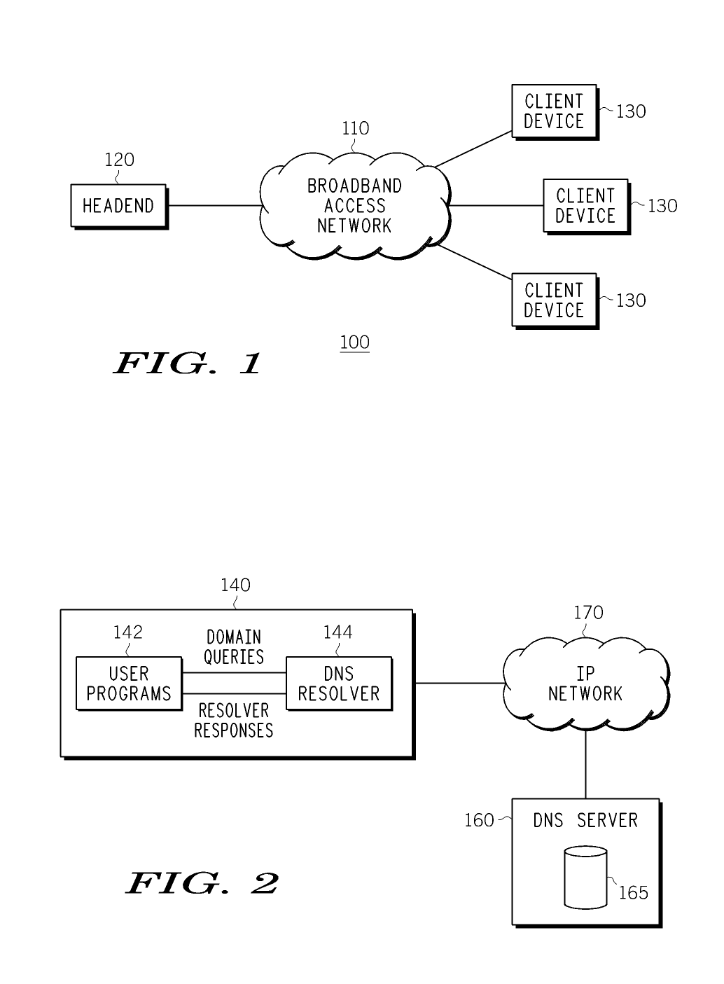

FIG. 1 shows the architecture of one example of a communication system 100 that can be used to deliver video and other content and services to subscribers in a packet switched manner using an IP or other network-level protocol. Communications system 100 is representative of a network architecture in which subscribers associated with client devices 130 (e.g., PCs, PDAs, portable computers, media centers, portable media players, mobile telephones and set-top boxes) are in communication with a broadband access network 110 such as an HFC network, for example. A headend 120 is in communication with the client devices 130 over the broadband network 110. The headend 120 is the facility from which a network operator broadcasts/multicasts/unicasts television signals and provides other services over the network. The Broadband access network 110 and headend 120 are typically provided by an MSO (Multi-Service Operator). The broadband access network 110 is also referred to herein as a cable data network. Broadband access network 110 is typically an all-coaxial or a hybrid-fiber/coax (HFC) network. Of course, other broadband access networks such as xDSL (e.g., ADSL, ADLS2, ADSL2+, VDSL, and VDSL2) and satellite systems may also be employed.

Broadband access network 110 may employ any suitable network-level protocols to provide communication among the various networked devices. While the IP protocol suite is used in the particular implementations described herein, other standard and/or proprietary communication protocols are suitable substitutes. For example, X.25, ARP, RIP, UPnP or other protocols may be appropriate in particular installations.

Broadband network 110 includes all routers, switches, long haul and metropolitan transport, and access systems necessary for transporting the video streams and the associated management and license data. Thus, network 110 supports transport of video-on-IP unicast and multicast content, and could be IP router and switch based, where IP multicast replication is accomplished by core and edge routers.

For large amounts of data to be distributed to a large number of subscribers over a packet switched network, IP (or other network-level) multicasting is more efficient than normal Internet transmissions because a server can broadcast data/messages to many recipients simultaneously. Unlike traditional Internet traffic that requires separate connections (single-cast addressing) for each source—destination pair, IP multicasting allows many recipients to share the same source. This means that just one set of packets is transmitted for all destinations. To receive a multicast, a subscriber listens to a specific IP address on a multicast-enabled network, like tuning a television to a specific channel. Multicast broadcast is particularly suitable for distribution of multimedia (video, audio, data) content. When the IP suite is employed, the content is generally transmitted as an MPEG packet stream on a pre-established UDP port and the MPEG packets are encapsulated in UDP/IP datagrams.

Internet Group Management Protocol (IGMP) is defined in RFC 1112 as the Internet standard for IP multicasting. IGMP establishes host memberships in particular multicast groups on a single network and allows a host to inform its local router that it wants to receive data addressed to a specific multicast group. The edge routers of network 110 are provided with IGMP (Internet Group Management Protocol) to enable IGMP switching for IP Multicasts, Broadcast Television and the special IP multicast information. QoS for subscriber services is implemented using IP queuing in the edge router. For example, highest priority may be given to Video on Demand and Broadcast Video while lower priority is given to High Speed Internet. The edge routers may also be enabled with static routing of the most popular broadcast channels to improve channel change times.

As previously mentioned, when a subscriber wishes to access programming that is being digitally broadcast, the subscriber usually selects a virtual channel number that is associated with the programming. The subscriber may obtain the virtual channel number from an Electronic Program Guide (EPG) that is often made available by the MSO. However, when the programming is made available using a network level protocol such as IP, the client device needs to acquire the corresponding multicast address at which the program is available. Requiring the user to determine the appropriate multicast address is cumbersome for the user.

In accordance with the techniques described herein, in an IP digital television environment, the virtual channel corresponds to a domain name. For example, one virtual channel number may have the domain name 001.vcn.fiostv.motorola.net while another virtual channel number may have the domain name 002.vcn.fiostv.motorola.net. In order to map this domain name to the appropriate IP multicast address without user intervention, a Domain Name Service (DNS) may be employed. A DNS, as used in the environment of computer networks such as the Internet, is a tool for mapping domain names to an IP address. For example, the domain name “www.motorola.com” may be mapped to an IP address such as “168.84.151.9”. The DNS provides a hierarchical domain-based naming scheme and a distributed database system for implementing the naming scheme.

In operation, when an application program such as a web browser needs an IP address, it calls a library procedure known as a resolver, and passes the domain name to it. The resolver sends a data packet to a local DNS server, which looks up the name and returns the IP address to the resolver. The resolver provides the IP address to the application, which can use it to establish a connection with the computer represented by the domain name, such as a server.

FIG. 2 shows one example of a client device 140 (e.g., client devices 130 in FIG. 1) that can be used to access programming using a DNS. The client device 140 can be any device such as a set-top box that desires to receive a broadcast by resolving the domain name of a virtual channel into an IP or other network address. The client device 140 includes a user program 142 through which the user accesses digital media content. The user program 142 may include an interactive program guide function and a web browser. The user program 142 communicates with a DNS capable resolver 144. The resolver 144 communicates with a DNS server 160 over IP network 170 using DNS. (In some cases the infrastructure of IP network 170 may be coextensive in whole or in part with broadband access network 110 in FIG. 1). The client 140 has obtained an IP address, using any appropriate protocol such as the Dynamic Host Configuration Protocol (DHCP), which is commonly used by client devices to obtain IP addresses.

The DNS server 160 includes a database or storage device 165 for storing the domain names of virtual channels and their associated multicast IP addresses. The DNS server 160 is authoritative for one or more sub-domains in the IP network. For example, DNS server 160 may be authoritative for the sub-domain vcn.tv.motorola.net. Accordingly, the database 165 will include entries such as:

| Domain Name of Virtual Channel | Multicast IP Address |
|---|---|
| 001.vcn.tv.motorola.net | 226.17.30.001 |
| 002.vcn.tv.motorola.net | 226.17.30.002 |

Each entry of the database 165 includes two fields. The first field represents a fully qualified domain name for a virtual channel number and the second field is the multicast address associated with the domain name. In general, the database 165 will include one entry for each virtual channel that is available.

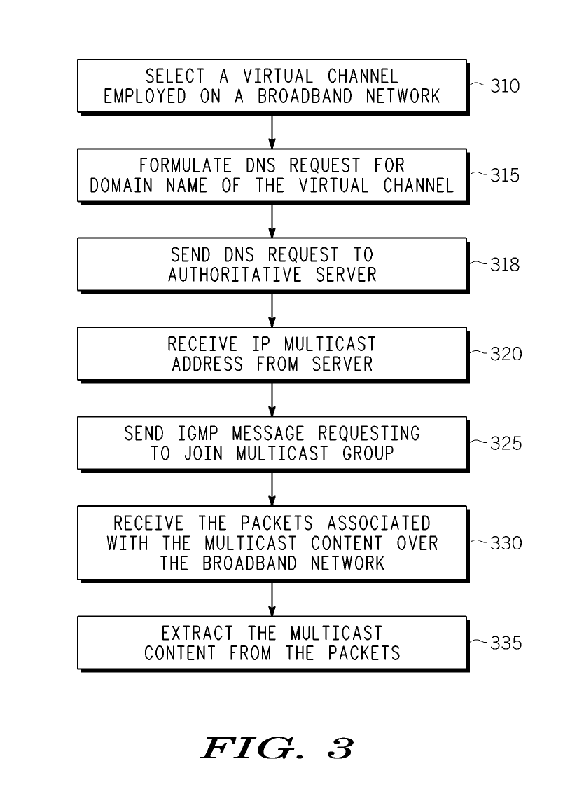

FIG. 3 is a flowchart showing one example of a method employed by a subscriber to access a multicast broadcast using the techniques described above. In step 310 the subscriber, using the client device, selects a virtual channel associated with the service he or she would like to receive (e.g., view a broadcast program). The virtual channel may be obtained from the EPG that is made available to the subscriber by the MSO over the broadband network. Alternatively, if the subscriber is already aware of the virtual channel that is desired, the subscriber may enter it directly. The client program provides the domain name of the virtual channel to the resolver in the client device, and formulates a DNS request in step 315. The request is sent to the appropriate DNS server in step 318 that is authoritative for the subdomain in which the domain name belongs. In response to the request, the DNS server accesses its database to retrieve the appropriate IP multicast address corresponding to the domain name, which is forwarded over the network and received by the client device in step 320. The client device sends an IGMP message to an edge router in the network in step 325 requesting to join the multicast group associated with the IP multicast address. Once the client device has joined the group the network will forward to the client device the packets originating from the headend, which packets are destined for the multicast group resulting in a flow of digital data to the client device The packets are received in step 330. That is, the headers of the packets will have the multicast address of the group as their destination address. In step 335 the client device processes the packets to extract the content that the subscriber desires.

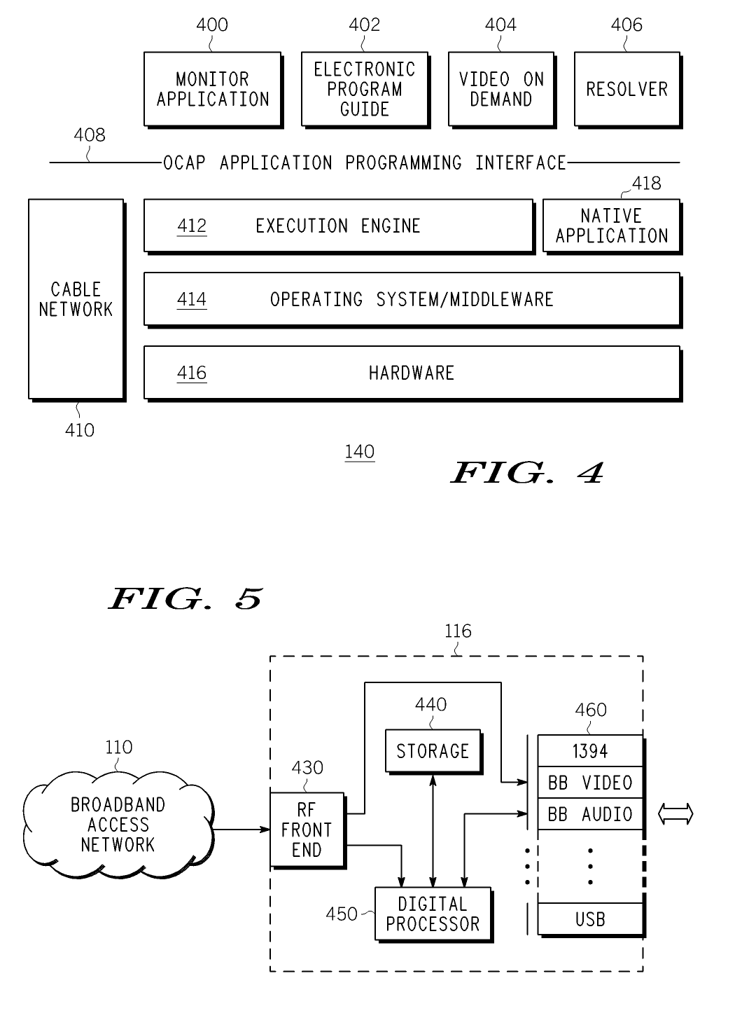

FIG. 4 shows the logical architecture of one particular example of client device 140. In this example the client device 140 is illustrated as a set-top terminal that is compliant with the OpenCable Application Platform (OCAP) hardware and software environment. The OCAP specification is a middleware software layer specification intended to enable the developers of interactive television services and applications to design such products so that they will run successfully on any cable television system, independent of set-top or television receiver hardware or operating system software choices. As is well known, middleware generally comprises one or more layers of software which are positioned “between” application programs and the lower or physical layers of the network device. Middleware is commonly written for the specific requirements of the operator of the computer system, and the proprietary software purchased by the operator of the computer system. A key role of middleware is to insulate the application programs from the device specific details. By using middleware the application programmers need know very little about the actual network details, since they can rely on the middleware to address the complexities of interfacing with the network. Of course, the client device 140 is not limited to an OCAP-compliant software/hardware architecture. In other cases, for example, the client devices 106 may be compliant with MHEG, DASE or Multimedia Home Platform (MHP) middleware. Alternatively, the client devices 140 may be based on a proprietary architecture.

Referring to FIG. 4, the top of an OCAP software “stack” includes a Monitor Application 400, Electronic Program Guide (EPG) 402, Video-on-Demand Application 404, and a Resolver 406. These applications are run on top of a software layer called the “Execution Engine” 412 and interface to the Execution Engine using the well known OCAP APIs 408. The client device may also include certain software applications or “Native Applications” 418 that do not run within the Execution Engine, but run directly on top of the Operating System/Middleware 414 for the client device. Native Applications are typically written for, e.g., a particular hardware configuration 416 of the client device 140. Examples of such Native Applications may include management of front panel functionality, remote control interaction, games, and the like. The objects downloaded to the client device in accordance with the techniques described herein may include any of the aforementioned application objects as well as additional application or other objects.

FIG. 5 shows one example of the client device hardware 416. The device hardware 416 generally includes a front end 430 (e.g., a network interface such as an Ethernet interface)for interfacing with the IP or other network 110 of FIG. 1, digital processor(s) 450, storage device 440, and a plurality of interfaces 460 (e.g., video/audio interfaces, IEEE-1394 “Firewire”, USB, serial/parallel ports, etc.) for establishing communication with other end-user devices such as televisions, personal electronics, computers, WiFi or other network hubs/routers, etc. Other components which may be utilized within the device include RF tuner and decoder stages, various processing layers (e.g., DOCSIS MAC, OOB channels, MPEG, etc.) as well as media processors and other specialized SoC or ASIC devices. These additional components and functionality are well known to those of ordinary skill in the art and accordingly are not described further herein.

The processes described above, including those shown in FIG. 3, may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Although various embodiments and examples are specifically illustrated and described herein, it will be appreciated that modifications and variations are covered by the above teachings and are within the purview of the appended claims.

1. At least one computer-readable medium encoded with instructions which, when executed by a processor, performs a method including:
receiving a user request to acquire from a broadband network content that is associated with a virtual channel number that represents a content broadcaster;
requesting from a Domain Name Service (DNS) server a network level multicast address corresponding to a domain name of the virtual channel number;
receiving from the DNS server the network level multicast address;
sending to the broadband network a request to join a multicast group associated with the network level multicast address; and
in response to the request to join the multicast group, receiving from the broadcast network packets in which the content is embodied, wherein the packets have headers with a destination address corresponding to the network level multicast address.

2. The computer-readable medium of claim 1 wherein the network level multicast address is an IP protocol multicast address.

3. The computer-readable medium of claim 1 wherein the user request is received through an Electronic Program Guide (EPG) provided over the broadband network.

4. The computer-readable medium of claim 1 wherein communication to and from the DNS server is in accordance with a Domain Name Server Protocol (DNS).

5. The computer-readable medium of claim 1 wherein the request to join the multicast group is sent in accordance with an Internet Group Management Protocol (IGMP).

6. The computer-readable medium of claim 1 wherein the virtual channel number conforms to an Advanced Television Systems Committee (ATSC) Standard.

7. The computer-readable medium of claim 1 wherein the user request is received by a set top box.

8. A set top box, comprising:
a front-end for receiving programming content over a broadband communication network;
a processor operatively associated with the front-end; and
a resolver operatively associated with the processor for determining a network-level multicast address corresponding to a domain name of a virtual channel on which the broadcast programming is available.

9. The set top box of claim 8 further comprising an EPG unit operatively associated with the resolver for providing the domain name of the virtual channel thereto.

10. The set top box of claim 8 wherein the resolver is configured to request from a Domain Name Service (DNS) server the network level multicast address corresponding to the domain name of the virtual channel number and receive from the DNS server the network level multicast address.

11. The set top box of claim 8 wherein the processor is configured to cause a message to be sent to the broadband network requesting to join a multicast group associated with the network level multicast address.

12. The set top box of claim 8 wherein the network level multicast address is an IP protocol multicast address.

13. The set top box of claim 10 wherein communication to and from the DNS server is in accordance with a Domain Name Service (DNS).

14. The set top box of claim 11 wherein the request to join the multicast group is sent in accordance with an Internet Group Management Protocol (IGMP).

15. The set top box of claim 8 further comprising:
a storage device operatively associated with the processor; and
an OCAP-compliant software stack residing on the storage device.

16. The set top box of claim 15 wherein the resolver is incorporated in the OCAP-compliant software stack.
